(19) United States
(12) Patent Application Publication
(10) Pub. No.: US 2026/0332954 A1
(43) Pub. Date: Oct. 22, 2026

(54) AUDIO OUTPUT METHOD, DEVICE, READABLE STORAGE MEDIUM, AND COMPUTER PROGRAM PRODUCT

(71) Applicant: GOERTEK INC., Weifang (CN)

(72) Inventors: Guangsheng LIU, Weifang (CN); Yu ZHOU, Weifang (CN); Rongliang XIE, Weifang (CN); Yuping ZHAO, Weifang (CN); Zongxia ZHU, Weifang (CN); Ruozhou HUANG, Weifang (CN); Jianpeng YIN, Weifang (CN); Jie WU, Weifang (CN); Kang AN, Weifang (CN)

(21) Appl. No.: 19/711,204

(22) Filed: Jun. 17, 2026

Related U.S. Application Data
(63) Continuation of application No. PCT/CN2025/117144, filed on Aug. 27, 2025.

(30) Foreign Application Priority Data
Oct. 29, 2024 (CN) 202411526202.X

(51) Int. Cl. H04R 3/12; H04R 1/10; H04R 1/28; H04R 3/04

(52) U.S. Cl. CPC H04R 3/12; H04R 1/1008; H04R 1/1083; H04R 1/2811; H04R 3/04; H04R 2460/01

(57) ABSTRACT

An audio output method is applied to an audio device. The audio device includes a main speaker unit and a secondary speaker unit, and the audio output method includes the following steps: obtaining an original signal to be output, and obtaining a target signal based on the original signal; and outputting the original signal through the main speaker unit, and outputting the target signal through the secondary speaker unit, in response to that the secondary speaker unit is forward-connected, the original signal and the target signal have opposite phases and identical signal amplitudes within a preset frequency range; or in response to that the secondary speaker unit is reverse-connected, the original signal and the target signal have identical phases and identical signal amplitudes within the preset frequency range.

### CROSS-REFERENCE TO RELATED APPLICATIONS

This application is a continuation application of International Application No. PCT/CN2025/117144, filed on Aug. 27, 2025, which claims priority to Chinese Patent Application No. 202411526202.X, filed on Oct. 29, 2024. The disclosures of the above-mentioned applications are incorporated herein by reference in their entireties.

### TECHNICAL FIELD

The present application relates to the technical field of signal processing, and in particular, to an audio output method, a device, a readable storage medium, and a computer program product.

### BACKGROUND

Open-ear wearable speakers (OWS), as a type of audio device, are highly popular due to their comfortable wearing experience and lack of occlusion. However, due to the open design of OWS, during sound transmission, the sound played in the wearer's ear canal is also conducted through the air into the free space surrounding the wearer. Therefore, sound leakage is a common problem, which compromises user privacy and results in poor acoustic privacy. Therefore, how to improve the privacy of open-ear headphones when using them is a technical problem urgently to be solved in this technical field.

### SUMMARY

The main purpose of the present application is to provide an audio output method, a device, a readable storage medium, and a computer program product, aiming to solve the technical problem of how to improve the privacy of open-ear headphones when using them.

To achieve the above purpose, the present application provides an audio output method. The audio output method is applied to an audio device. The audio device includes a main speaker unit and a secondary speaker unit. The audio output method includes the following steps:
obtaining an original signal to be output, and obtaining a target signal based on the original signal; and
outputting the original signal through the main speaker unit, and outputting the target signal through the secondary speaker unit,
in response to that the secondary speaker unit is forward-connected, the original signal and the target signal have opposite phases and identical signal amplitudes within a preset frequency range; or
in response to that the secondary speaker unit is reverse-connected, the original signal and the target signal have identical phases and identical signal amplitudes within the preset frequency range.

In an embodiment, when the secondary speaker unit is reverse-connected, the step of obtaining the target signal based on the original signal includes:
performing filtering processing on the original signal to obtain a first filtered signal and a second filtered signal, wherein the first filtered signal is a signal whose signal frequency belongs to the preset frequency range, and the second filtered signal is a signal whose signal frequency does not belong to the preset frequency range;
obtaining a first signal based on the first filtered signal, wherein the first signal and the first filtered signal have identical phases and identical signal amplitudes;
obtaining a second signal based on the second filtered signal, wherein the second signal and the second filtered signal have opposite phases; and
combining the first signal and the second signal to obtain the target signal.

In an embodiment, the audio device further includes a phase inverter and an equalizer connected in sequence, and the step of obtaining the second signal based on the second filtered signal includes:
inputting the second filtered signal to the phase inverter to output a phase-inverted signal; and
inputting the phase-inverted signal to the equalizer to output the second signal.

In an embodiment, the audio device further includes a low-pass filter, a high-pass filter, and a band-pass filter, a cutoff frequency of the low-pass filter is a lower limit value of the preset frequency range, a cutoff frequency of the high-pass filter is an upper limit value of the preset frequency range, a passband frequency range of the band-pass filter is the preset frequency range, and the step of performing filtering processing on the original signal to obtain the first filtered signal and the second filtered signal includes:
inputting the original signal to the low-pass filter to output a low-frequency signal;
inputting the original signal to the high-pass filter to output a high-frequency signal;
inputting the original signal to the band-pass filter to output a mid-high frequency signal; and
determining the mid-high frequency signal as the first filtered signal, and determining the low-frequency signal and the high-frequency signal as the second filtered signal.

In an embodiment, the audio device further includes a first power amplifier and a second power amplifier, the first power amplifier is connected to the main speaker unit, the second power amplifier is connected to the secondary speaker unit, and before the step of outputting the original signal through the main speaker unit and outputting the target signal through the secondary speaker unit, the method further includes:
inputting the original signal to the first power amplifier, so as to amplify the original signal through the first power amplifier and drive the original signal to the main speaker unit for output; and
inputting the original signal to the second power amplifier, so as to amplify the target signal through the second power amplifier and drive the target signal to the secondary speaker unit for output.

In an embodiment, the preset frequency range is a frequency range between a front cavity resonance frequency of the secondary speaker unit and a rear cavity resonance frequency of the secondary speaker unit.

In an embodiment, the rear cavity resonance frequency of the secondary speaker unit is less than 2 kHz, and the front cavity resonance frequency of the secondary speaker unit is greater than the rear cavity resonance frequency of the secondary speaker unit.

Furthermore, to achieve the above purpose, the present application further provides an audio device. The audio device includes a main speaker unit, a secondary speaker unit, and a processor. The main speaker unit and the secondary speaker unit are respectively connected to the processor. The processor is configured to execute the steps of the audio output method as described above.

Furthermore, to achieve the above purpose, the present application further provides a readable storage medium. The readable storage medium is a computer-readable storage medium. A program for implementing the audio output method is stored on the computer-readable storage medium. When the program for implementing the audio output method is executed by a processor, the steps of the audio output method as described above are implemented.

The present application further provides a computer program product, including a computer program. When the computer program is executed by a processor, the steps of the audio output method as described above are implemented.

One or more technical solutions proposed by the present application have at least the following technical effects:

By arranging the main speaker unit and the secondary speaker unit in the audio device, outputting the original signal through the main speaker unit, and when the secondary speaker unit is forward-connected, outputting a target signal through the secondary speaker unit that has an opposite phase and the same signal amplitude as the original signal within the preset frequency range; when the secondary speaker unit is reverse-connected, outputting a target signal through the secondary speaker unit that has the same phase and the same signal amplitude as the original signal. It can be understood that when a speaker is reverse-connected, its output signal will also be phase-inverted. That is, within the preset frequency range, the secondary speaker unit generates a target signal that is out of phase with and has the same signal amplitude as the main speaker unit, so that the audio signals generated by the main speaker unit and the secondary speaker unit destructively interfere within the preset frequency range. Consequently, non-wearers of the audio device cannot hear the audio signals within the preset frequency range, thereby improving the privacy of the audio device when used by the wearer. As open-ear headphones are a type of audio device, applying the technical solution proposed by the present application to open-ear headphones naturally improves their privacy as well.

### BRIEF DESCRIPTION OF THE DRAWINGS

The accompanying drawings, which are incorporated in and constitute a part of this specification, illustrate embodiments consistent with the present application and together with the description serve to explain the principles of the present application.

In order to more clearly illustrate the technical solutions in the embodiments of the present application or in the prior art, the drawings required to be used in the description of the embodiments or the prior art will be briefly introduced below. Obviously, for those of ordinary skill in the art, other drawings can also be obtained based on these drawings without creative labor.

FIG. 1 is a schematic flowchart of a first embodiment of an audio output method of the present application.

FIG. 2 is a schematic structural diagram of a speaker unit involved in an embodiment of the audio output method of the present application.

FIG. 3 is a schematic flowchart of obtaining a target signal involved in an embodiment of the audio output method of the present application.

FIG. 4 is another schematic flowchart of obtaining a target signal involved in an embodiment of the audio output method of the present application.

FIG. 5 is another schematic flowchart of obtaining a target signal involved in an embodiment of the audio output method of the present application.

FIG. 6 is a schematic structural diagram of an audio output apparatus of the present application.

FIG. 7 is a schematic structural diagram of a hardware operating environment of a device involved in the audio output apparatus of an embodiment of the present application.

The realization of the purpose, functional features, and advantages of the present application will be further described in conjunction with the embodiments and with reference to the accompanying drawings.

### DETAILED DESCRIPTION OF THE EMBODIMENTS

In order to make the above objects, features, and advantages of the present application more clearly understandable, the technical solutions in the embodiments of the present application will be clearly and completely described below in conjunction with the accompanying drawings in the embodiments of the present application. Obviously, the described embodiments are only a part of the embodiments of the present application, rather than all the embodiments. Based on the embodiments of the present application, all other embodiments obtained by those of ordinary skill in the art without creative labor fall within the scope of the present application.

With the development of virtual reality and open-ear wearable speaker (OWS), near-ear open audio devices are increasingly favored by users due to their comfortable wearing experience. Due to a certain degree of distance from the ear canal (compared to in-ear and semi-open headphones) and compromises for wearing comfort, such products also face relatively unfavorable acoustic conditions. They face two major acoustic problems: First, insufficient low frequencies. Due to the open nature, their radiation condition changes from a pressure field to a near-free field, causing the sound radiation characteristics to tend towards a second-order high-pass form. Due to leakage, the low-frequency response attenuates rapidly. For existing near-ear open audio devices, the frequency response below 400 Hz begins to attenuate. Second, privacy issues caused by sound leakage. Due to the certain distance from the ear canal, to achieve sufficient loudness, compared to traditional headphones, such devices require the speaker to produce a larger amplitude to meet the wearer's loudness requirements. However, this also leads to a large amount of sound leaking to the far field, allowing people near the wearer to hear the playback content, causing sound leakage problems and reducing privacy.

To solve this problem, a dipole acoustic design method can be adopted: actively opening the rear cavity of the speaker, introducing an acoustic short circuit, localizing sound waves near the near field to improve privacy, while the open rear cavity reduces speaker stiffness and significantly improves low-frequency amplitude. However, this design method also has significant drawbacks. First, low-frequency acoustic short circuit. For the near field, opening the rear cavity also introduces interference between front and rear sound radiation, leading to sound cancellation in out-of-phase frequency bands, causing a reduction in mid-low frequencies. Second, the privacy frequency band is narrow. Due to the numerous series and parallel resonance characteristics of the acoustic system formed by the speaker diaphragm and the front/rear cavities, at certain mid-high frequency points, the amplitude and phase of the front/rear cavity sound radiation begin to mismatch, no longer meeting the dipole acoustic conditions. This causes the acoustic short circuit to fail, and may even cause enhanced sound radiation, leading to the failure of the product's acoustic privacy design and causing sound leakage.

Based on this, the main solution of the present application is: the audio device is provided with a main speaker unit and a secondary speaker unit, obtaining an original signal to be output, and obtaining a target signal based on the original signal; outputting the original signal through the main speaker unit, and outputting the target signal through the secondary speaker unit; wherein, if the secondary speaker unit is forward-connected, within a preset frequency range, the original signal and the target signal have opposite phases and identical signal amplitudes; if the secondary speaker unit is reverse-connected, within the preset frequency range, the original signal and the target signal have identical phases and identical signal amplitudes.

By arranging a main speaker unit and a secondary speaker unit in the audio device, outputting the original signal through the main speaker unit, and when the secondary speaker unit is forward-connected, outputting a target signal through the secondary speaker unit that has an opposite phase and the same signal amplitude as the original signal within the preset frequency range; when the secondary speaker unit is reverse-connected, outputting a target signal through the secondary speaker unit that has the same phase and the same signal amplitude as the original signal. It can be understood that when a speaker is reverse-connected, its output signal will also be phase-inverted. That is, within the preset frequency range, the secondary speaker unit generates a target signal that is out of phase with and has the same signal amplitude as the main speaker unit, so that the audio signals generated by the main speaker unit and the secondary speaker unit destructively interfere within the preset frequency range. Consequently, non-wearers of the audio device cannot hear the audio signals within the preset frequency range, thereby improving the privacy of the audio device when used by the wearer. As open-ear headphones are a type of audio device, applying the technical solution proposed by the present application to open-ear headphones naturally improves their privacy as well.

It should be noted that the execution subject of each embodiment of the audio output method of the present application may be an audio device or the like capable of implementing the above functions, such as OWS headphones. Exemplarily, the description and explanation of each embodiment of the audio output method of the present application will be illustrated using OWS headphones as an example.

Based on this, the present application proposes a first embodiment of an audio output method. The audio device includes a secondary speaker unit and a main speaker unit. Referring to FIG. 1, the audio output method includes steps S10 to S20:

Step S10: obtaining an original signal to be output, and obtaining a target signal based on the original signal.

If the secondary speaker unit is forward-connected, the original signal and the target signal have opposite phases and identical signal amplitudes within a preset frequency range; if the secondary speaker unit is reverse-connected, the original signal and the target signal have identical phases and identical signal amplitudes within the preset frequency range.

The main speaker unit may be the primary sound output unit in an OWS headphone, responsible for generating the main audio content. It typically has high power handling capability and good sound quality performance to ensure sound clarity and dynamic range. The secondary speaker unit may be a unit configured to supplement the audio experience and be responsible for active sound leakage control.

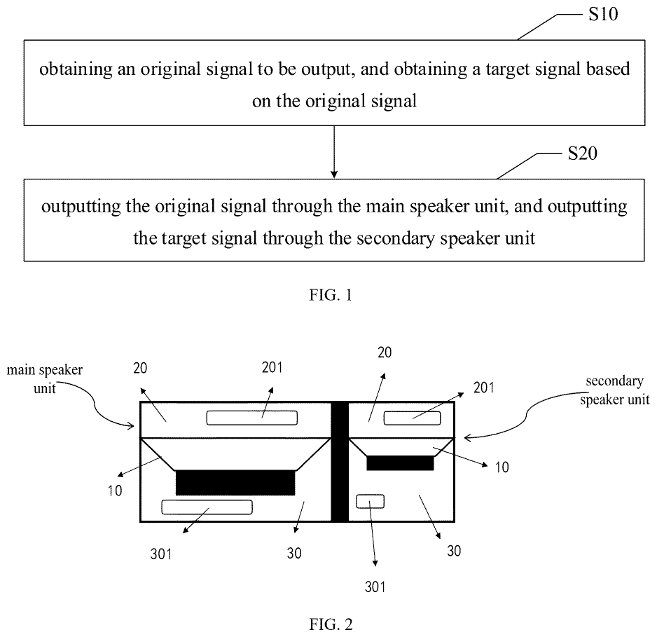

Referring to FIG. 2, both the main speaker unit and the secondary speaker unit may specifically be sound-producing units including at least one speaker 10.

Further, referring to FIG. 2, both the main speaker unit and the secondary speaker unit include a front cavity 20 and a rear cavity 30. The front cavity 20 is the space in front of the speaker, i.e., the space in front of the speaker diaphragm. The rear cavity 30 is the space behind the speaker, i.e., the space behind the speaker diaphragm. Both the front cavity 20 and the rear cavity 30 may be fully enclosed or partially enclosed enclosures.

Further, referring to FIG. 2, both the front cavity 20 and the rear cavity 30 are partially enclosed enclosures. The front cavity 20 has at least one sound outlet hole 201, and the rear cavity 30 has at least one sound outlet hole 301. That is, both the main speaker unit and the secondary speaker unit have open front and rear cavities.

Further, referring to FIG. 2, the volume of the secondary speaker unit is smaller than the volume of the main speaker unit.

Further, the sound outlet hole of the front cavity in the main speaker unit faces the ear canal.

The secondary speaker unit may be forward-connected or reverse-connected. Forward connection means that the positive terminal of the speaker in the secondary speaker unit is connected to the positive output of the power amplifier, and the negative terminal is connected to the negative output of the power amplifier. Reverse connection means that the positive terminal of the speaker in the secondary speaker unit is connected to the negative output of the power amplifier, and the negative terminal is connected to the positive output of the power amplifier. Exemplarily, the description and explanation of each embodiment of the present application will be illustrated using the secondary speaker unit being reverse-connected as an example.

When the secondary speaker unit is reverse-connected, the target signal has the same phase and the same signal amplitude as the original signal within the preset frequency range. It should be noted that the preset frequency range may be a frequency range pre-set by relevant personnel for expected privacy control. In layman's terms, it is expected that the audio device will not leak sounds within the preset frequency range to the external environment. For example, the preset frequency range may specifically be the full frequency band, greater than 400 Hz, less than 5 kHz, or greater than or equal to 400 Hz and less than or equal to 5 kHz, etc. This embodiment does not impose specific limitations. In a specific embodiment, considering that the human ear is most sensitive to leaked headphone sounds in the mid-frequency range, especially the 1 kHz to 3 kHz band, the preset frequency range may be 1 kHz to 3 kHz.

Outside the preset frequency range, the phase of the target signal and the original signal may be the same, opposite, or have other relationships, and the signal amplitude of the target signal may also be any value. This embodiment does not impose specific limitations. In layman's terms, outside the preset frequency range, the target signal may be any signal (including no signal, i.e., a null signal).

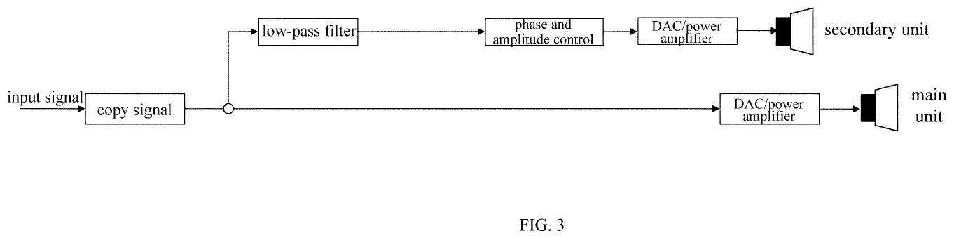

To obtain the target signal, filtering processing may be performed on the original signal to screen out the original signal within the preset frequency range, and then the target signal is obtained based on the screened original signal. Exemplarily, assuming the preset frequency range is less than or equal to 3 kHz, referring to FIG. 3, a low-pass filter with a cutoff frequency of 3 kHz may be set. After copying and inputting the original signal (shown as the input signal in FIG. 3) into the low-pass filter, the original signal less than or equal to 3 kHz is screened out is then performed on the screened signal to generate a target signal that has the same phase and the same signal amplitude as the original signal. The target signal is then driven to the secondary speaker unit (shown as the secondary unit in FIG. 3) for output after passing through Digital-to-Analog Converter (DAC) and a power amplifier. Meanwhile, the original signal is driven to the main speaker unit (shown as the main unit in FIG. 3) for output after passing through the DAC and the power amplifier. It can be understood that at this time, the target signal is a null signal outside the preset frequency range.

Further, the frequency range where the frequency response of the main speaker unit is less than a preset value is taken as an attenuation frequency range. Considering that the frequency response of the speaker in the attenuation frequency range is usually low, the audio performance of the OWS headphone in the attenuation frequency range is poor, and the wearer also has difficulty hearing sounds in the attenuation frequency range, which affects the wearer's listening experience. For example, the frequency response of a speaker typically begins to attenuate below 400 Hz, and it is also difficult for the wearer to hear low-frequency sounds. Based on this, in a preferred implementation, the preset frequency range may only include part of or exclude the attenuation frequency range, i.e., the attenuation frequency range is partially or entirely outside the preset frequency range. Furthermore, outside the preset frequency range, the target signal and the original signal have the same phase. In this way, outside the preset frequency range, the secondary speaker unit and the main speaker unit can work collaboratively to enhance the audio of the main speaker unit in the attenuation frequency range, while simultaneously performing privacy control on the audio within the preset frequency range where the frequency response is better. This balances both the privacy of the OWS headphone and its full-frequency audio performance, thereby improving the wearer's listening experience.

Further, the aforementioned preset value may be a value pre-set by relevant personnel based on experience or experimental summaries. When the frequency response is lower than this value, it usually causes the user to be unable to hear the sound or feel that certain characteristics of the sound are missing.

Step S20: outputting the original signal through the main speaker unit, and outputting the target signal through the secondary speaker unit.

After obtaining the target signal, the target signal is driven into the secondary speaker unit, and the original signal is driven into the main speaker unit, so that the main speaker unit and the secondary speaker unit output their corresponding signals. This generates signals with opposite phases and identical signal amplitudes within the preset frequency range, thereby achieving destructive interference in the far field of the sound waves and realizing privacy control within the preset frequency range.

It should be noted that after the main speaker unit and the secondary speaker unit output their corresponding signals, the sound is not completely canceled in the near field, thereby allowing the wearer of the OWS headphone to hear the sounds within the preset frequency range.

This embodiment improves the privacy of the OWS headphone by arranging a main speaker unit and a secondary speaker unit in the OWS headphone, outputting the original signal through the main speaker unit, and when the secondary speaker unit is forward-connected, outputting a target signal through the secondary speaker unit that has an opposite phase and the same signal amplitude as the original signal within the preset frequency range; when the secondary speaker unit is reverse-connected, outputting a target signal through the secondary speaker unit that has the same phase and the same signal amplitude as the original signal. It can be understood that when a speaker is reverse-connected, its output signal will also be phase-inverted. That is, within the preset frequency range, the secondary speaker unit generates a target signal that is out of phase with and has the same signal amplitude as the main speaker unit, so that the audio signals generated by the main speaker unit and the secondary speaker unit destructively interfere within the preset frequency range. Consequently, non-wearers of the OWS headphone cannot hear the audio signals within the preset frequency range generated by the OWS headphone, thereby improving the privacy of the OWS headphone when used by the wearer.

Based on the first embodiment of the present application, in a second embodiment of the present application, content identical or similar to the above first embodiment can refer to the introduction above and will not be repeated here. On this basis, when the secondary speaker unit is reverse-connected, the step of obtaining the target signal based on the original signal includes:

Step A10: performing filtering processing on the original signal to obtain a first filtered signal and a second filtered signal, where the first filtered signal is a signal whose signal frequency belongs to the preset frequency range, and the second filtered signal is a signal whose signal frequency does not belong to the preset frequency range.

It should be noted that one or more filters may be configured to perform filtering processing on the original signal to obtain the first filtered signal and the second filtered signal, and each filter may be a low-pass filter, a band-pass filter, or a high-pass filter. It is easy to understand that relevant personnel may set one or more filters based on the preset frequency range, as long as the first filtered signal and the second filtered signal can be obtained. This embodiment does not impose specific limitations.

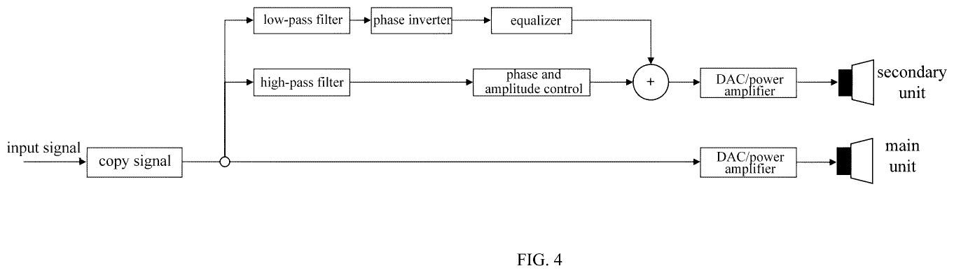

Exemplarily, referring to FIG. 4, assuming the preset frequency range is greater than or equal to 400 Hz, a high-pass filter with a cutoff frequency of 400 Hz may be set to perform filtering processing on the original signal to obtain the first filtered signal. Further, a low-pass filter with a cutoff frequency of less than or equal to 400 Hz may be set to perform filtering processing on the original signal to obtain the second filtered signal.

Step A20: obtaining a first signal based on the first filtered signal, wherein the first signal has the same phase and the same signal amplitude as the first filtered signal.

Step A30: obtaining a second signal based on the second filtered signal, wherein the second signal has an opposite phase to the second filtered signal.

Referring to FIG. 4, specifically, the second signal opposite to the second filtered signal may be obtained through a phase inverter.

It should be noted that the signal amplitude of the second signal may be any value, and this embodiment does not impose specific limitations.

Step A40: combining the first signal and the second signal to obtain the target signal.

The first signal and the second signal are combined to obtain the target signal. Specifically, referring to FIG. 4, this may be achieved by adding the first signal and the second signal to obtain the target signal.

In this embodiment, filtering processing is performed on the original signal to obtain the first filtered signal within the preset frequency range and the second filtered signal outside the preset frequency range. A first signal having the same phase and the same signal amplitude as the first filtered signal is obtained, and a second signal having an opposite phase to the second filtered signal is obtained. The first signal and the second signal are combined to obtain the target signal. In this way, within the preset frequency range, the target signal and the original signal have the same signal amplitude and the same phase, achieving privacy control within the preset frequency range; while outside the preset frequency range, the target signal and the original signal have opposite phases, achieving enhancement of the audio in this frequency band. This balances both the privacy and audio performance of the OWS headphone.

In a possible implementation, the audio device further includes a phase inverter and an equalizer connected in sequence. The step of obtaining the second signal based on the second filtered signal includes:

Step B10: inputting the second filtered signal to the phase inverter to output a phase-inverted signal.

Step B20: inputting the phase-inverted signal to the equalizer to output the second signal.

It should be noted that relevant personnel may set the parameters of the equalizer according to the actually desired audio effect to obtain the expected second signal. This example does not impose specific limitations.

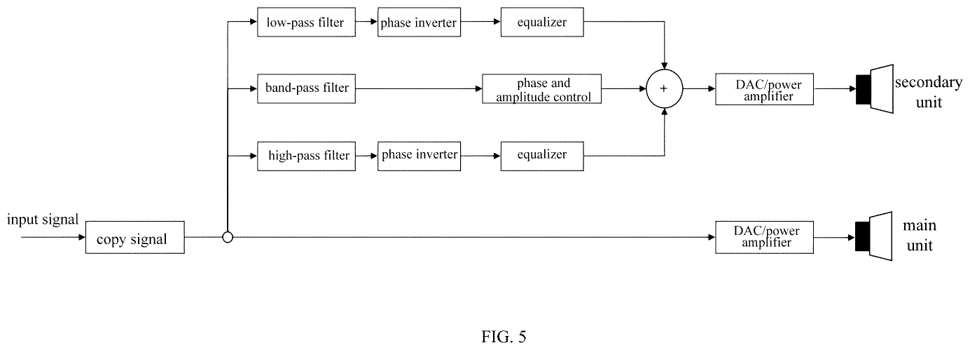

In a possible implementation, referring to FIG. 5, the audio device further includes a low-pass filter, a high-pass filter, and a band-pass filter. A cutoff frequency of the low-pass filter is a lower limit value of the preset frequency range, a cutoff frequency of the high-pass filter is an upper limit value of the preset frequency range, and a passband frequency range of the band-pass filter is the preset frequency range. The step of performing filtering processing on the original signal to obtain the first filtered signal and the second filtered signal includes:

Step C10: inputting the original signal to the low-pass filter to output a low-frequency signal.

It should be noted that when the preset frequency range has a lower limit value and an upper limit value, a low-pass filter, a high-pass filter, and a band-pass filter may be set in the OWS headphone to perform filtering processing on the original signal.

Let the lower limit value of the preset frequency range be fc1 and the upper limit value be fc2. The cutoff frequency of the low-pass filter may be set to fc1, the cutoff frequency of the high-pass filter may be set to fc2, the low-frequency cutoff frequency of the band-pass filter may be set to fc1, and the high-frequency cutoff frequency of the band-pass filter may be set to fc2, so that the passband frequency range of the band-pass filter is the preset frequency range.

It should be noted that whether the preset frequency range is (fc1, fc2), (fc1, fc2], [fc1, fc2), or [fc1, fc2], the lower limit value of the preset frequency range can be determined as fc1 and the upper limit value as fc2.

Step C20: inputting the original signal to the high-pass filter to output a high-frequency signal.

Step C30: inputting the original signal to the band-pass filter to output a mid-high frequency signal.

Step C40: determining the mid-high frequency signal as the first filtered signal, and determining the low-frequency signal and the high-frequency signal as the second filtered signal.

The low-frequency signal and the high-frequency signal are determined as the second filtered signal, so that after subsequent processing, the performance of the OWS headphone in the low-frequency and high-frequency ranges can be enhanced.

Based on the first embodiment and/or the second embodiment of the present application, in a third embodiment of the present application, content identical or similar to the above first and second embodiments can refer to the introduction above and will not be repeated here. On this basis, the audio device further includes a first power amplifier and a second power amplifier. The first power amplifier is connected to the main speaker unit, and the second power amplifier is connected to the secondary speaker unit. Before the step of outputting the original signal through the main speaker unit and outputting the target signal through the secondary speaker unit, the method further includes:

Step D10: inputting the original signal to the first power amplifier, so as to amplify the original signal through the first power amplifier and drive it to the main speaker unit for output;

Step D20: inputting the original signal to the second power amplifier, so as to amplify the target signal through the second power amplifier and drive it to the secondary speaker unit for output.

It should be noted that, referring to FIG. 3 to FIG. 5, a DAC is further provided before the power amplifiers (including the first power amplifier and the second power amplifier). The target signal and the original signal sequentially pass through the DAC and the power amplifier before being input to the corresponding speaker units for output.

In this embodiment, independent power amplifiers are respectively provided before the main speaker unit and the secondary speaker unit to amplify the corresponding signals for output. In this way, by controlling the first power amplifier and the second power amplifier to work synchronously, the main speaker unit and the secondary speaker unit can output signals synchronously, thereby improving the destructive interference effect of the two signals and further improving the privacy of the OWS headphone.

In a possible implementation, the preset frequency range is a frequency range between a front cavity resonance frequency of the secondary speaker unit and a rear cavity resonance frequency of the secondary speaker unit.

By setting the preset frequency range to the frequency range between the front cavity resonance frequency and the rear cavity resonance frequency of the secondary speaker unit, the preset frequency range is consistent with the frequency range between the front and rear cavity resonance frequencies of the secondary speaker unit. Relevant personnel can adjust the front and rear cavity resonance frequencies of the speaker to overlap with the frequency range prone to sound leakage, which can effectively enhance sound wave attenuation at these frequencies, thereby reducing the risk of sound leakage.

In a possible implementation, the rear cavity resonance frequency of the secondary speaker unit is less than 2 kHz, and the front cavity resonance frequency of the secondary speaker unit is greater than the rear cavity resonance frequency of the secondary speaker unit.

In this embodiment, the front cavity resonance frequency of the secondary speaker unit is greater than the rear cavity resonance frequency. The rear cavity resonance frequency mainly affects the low-frequency part of the speaker. A lower rear cavity resonance frequency means the speaker can resonate at lower frequencies, thereby improving the low-frequency response and sound fullness of the secondary speaker unit. The front cavity resonance frequency mainly affects the high-frequency part. A higher front cavity resonance frequency can make high-frequency sounds clearer and brighter. At the same time, having the front cavity resonance frequency greater than the rear cavity resonance frequency can avoid a deep trough in the mid-frequency range, which would cause the sound to be too quiet, thereby reducing distortion caused by resonance.

Exemplarily, to aid in understanding the technical concept or technical principle of the audio output method combining this embodiment with the first and second embodiments, a specific embodiment is listed below. In this specific embodiment, the audio output method is applied to an OWS headphone. The OWS headphone includes a main unit (i.e., main speaker unit), a secondary unit (i.e., secondary speaker unit), a power amplifier, a digital-to-analog converter (DAC), a low-pass filter, a high-pass filter, a band-pass filter, a phase inverter, an equalizer, and a digital signal processing (DSP) unit.

The main unit is primarily a speaker unit for radiating sound waves. This unit has a larger volume and is mainly configured to radiate sound waves to the human ear, constructing the main audio components and experience. The secondary unit is configured to supplement the audio experience and be responsible for active sound leakage control. The acoustic structure of this unit requires refined design, with two key indicators: fc1 and fc2. fc1 represents its rear cavity parallel resonance frequency, and fc2 represents its front cavity parallel resonance frequency. The cavities of the main unit and the secondary unit are independent and do not share a cavity. The diaphragm of the main unit divides the main unit front cavity and the main unit rear cavity. The diaphragm of the secondary unit divides the secondary unit front cavity and the secondary unit rear cavity. The rear cavity is defined as the part containing the magnetic circuit system of the speaker unit, and the front cavity is defined as the part not containing the magnetic circuit system. The rear cavity parallel resonance frequency fc1 of the secondary unit is less than 2 kHz, and the front cavity parallel resonance frequency fc2 of the secondary unit is greater than fc1. The frequency band from fc1 to fc2 is the active privacy control working frequency band of the secondary unit.

The power amplifier is configured to amplify signals to drive the speaker units. The DAC is configured to convert digital signals to analog signals. The DSP unit is a computer unit for implementing active control algorithms, which may be a microcontroller, a Field Programmable Gate Array (FPGA), or various embedded computing units.

The cutoff frequency of the low-pass filter is set to fc1. The corresponding phase inverter and equalizer are set according to performance effects. This frequency band utilizes the low-frequency response of the secondary unit, working collaboratively with the main unit to enhance the low-frequency performance of the audio system.

The low-frequency cutoff frequency of the band-pass filter is set to fc1, and the high-frequency cutoff frequency is set to fc2. The phase and amplitude control module ensures that the phase of the sound waves radiated by the secondary unit in this frequency band is opposite to that of the main unit and the signal amplitudes are identical. Since in the frequency band above fc1, the sound waves from the rear sound outlet hole of the secondary unit undergo phase inversion, the secondary unit system at this time resembles a bass-reflex (ported) speaker, forming an in-phase dipole. At this time, the far-field radiation capability of the secondary unit system is strongest and can be configured to cancel the sound waves radiated by the main unit, thereby achieving active privacy control.

The cutoff frequency of the high-pass filter is set to fc2. The corresponding phase inverter, equalizer, and performance effects are set accordingly. This frequency band utilizes the high-frequency response of the secondary unit, working with the main unit system to enhance the high-frequency performance of the audio. Since the secondary unit is usually smaller in volume, its high-frequency performance is far superior to that of the main unit. At this time, the system resembles a two-way crossover audio system.

Based on this, referring to FIG. 5, the audio output process is as follows:

The input signal (i.e., the original signal) is sequentially split into three paths and copied into the low-pass filter, band-pass filter, and high-pass filter, respectively. One path sequentially passes through the low-pass filter, phase inverter, and equalizer. One path sequentially passes through the band-pass filter and phase/amplitude control. One path sequentially passes through the high-pass filter, phase inverter, and equalizer. The three paths of signals are then merged. The merged three paths of signals are added together and input to the DAC. After sequentially passing through the DAC and the power amplifier, the signal is output through the secondary unit. Simultaneously, the input signal sequentially passes through the DAC and the power amplifier and is output through the main unit.

The above strategy significantly improves the utilization rate of the secondary unit: in the low-frequency range, the secondary unit acts as a sound-producing unit working collaboratively with the main unit to enhance low-frequency response; in the fc1 to fc2 frequency band, the secondary unit acts as a cancellation unit to enhance the acoustic privacy of the speaker system; in the high-frequency range, the secondary unit acts as a tweeter to enhance the high-frequency performance of the audio.

It should be noted that the above example is only to assist in understanding the present application and does not constitute a limitation on the structure of the audio device and the audio output method of the present application. More simple transformations based on this technical concept are all within the protection scope of the present application.

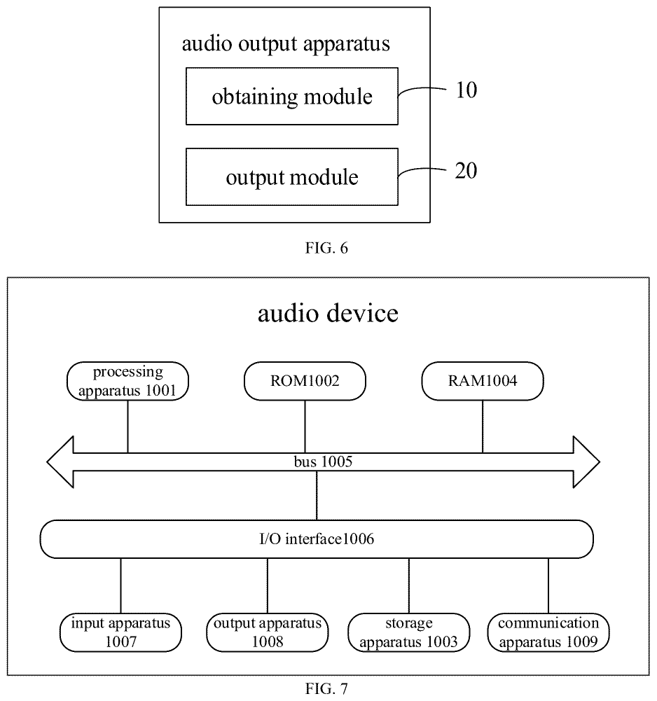

Furthermore, an embodiment of the present application further proposes an audio output apparatus. The audio output apparatus includes an audio device. The audio device includes a main speaker unit and a secondary speaker unit. Referring to FIG. 6, the audio output apparatus further includes an obtaining module 10 and an output module 20.

The obtaining module 10 is configured to obtain an original signal to be output, and obtain a target signal based on the original signal.

The output module 20 is configured to output the original signal through the main speaker unit, and output the target signal through the secondary speaker unit.

If the secondary speaker unit is forward-connected, the original signal and the target signal have opposite phases and identical signal amplitudes within a preset frequency range; if the secondary speaker unit is reverse-connected, the original signal and the target signal have identical phases and identical signal amplitudes within the preset frequency range.

In an embodiment, the obtaining module 10 is further configured to:
perform filtering processing on the original signal to obtain a first filtered signal and a second filtered signal, wherein the first filtered signal is a signal whose signal frequency belongs to the preset frequency range, and the second filtered signal is a signal whose signal frequency does not belong to the preset frequency range; obtain a first signal based on the first filtered signal, wherein the first signal has the same phase and the same signal amplitude as the first filtered signal; obtain a second signal based on the second filtered signal, wherein the second signal has an opposite phase to the second filtered signal; combine the first signal and the second signal to obtain the target signal.

In an embodiment, the audio device further includes a phase inverter and an equalizer connected in sequence. The obtaining module 10 is further configured to:
input the second filtered signal to the phase inverter to output a phase-inverted signal; input the phase-inverted signal to the equalizer to output the second signal.

The audio device further includes a low-pass filter, a high-pass filter, and a band-pass filter. A cutoff frequency of the low-pass filter is a lower limit value of the preset frequency range, a cutoff frequency of the high-pass filter is an upper limit value of the preset frequency range, and a passband frequency range of the band-pass filter is the preset frequency range. The obtaining module 10 is further configured to:
input the original signal to the low-pass filter to output a low-frequency signal;
input the original signal to the high-pass filter to output a high-frequency signal;
input the original signal to the band-pass filter to output a mid-high frequency signal;
determine the mid-high frequency signal as the first filtered signal, and determine the low-frequency signal and the high-frequency signal as the second filtered signal.

The audio device further includes a first power amplifier and a second power amplifier. The first power amplifier is connected to the main speaker unit, and the second power amplifier is connected to the secondary speaker unit. The audio output apparatus further includes a driving module. The driving module is configured to:
input the original signal to the first power amplifier, so as to amplify the original signal through the first power amplifier and drive it to the main speaker unit for output;
input the original signal to the second power amplifier, so as to amplify the target signal through the second power amplifier and drive it to the secondary speaker unit for output.

In an embodiment, the preset frequency range is a frequency range between a front cavity resonance frequency of the secondary speaker unit and a rear cavity resonance frequency of the secondary speaker unit.

In an embodiment, the rear cavity resonance frequency of the secondary speaker unit is less than 2 kHz, and the front cavity resonance frequency of the secondary speaker unit is greater than the rear cavity resonance frequency of the secondary speaker unit.

Furthermore, an embodiment of the present application further proposes an audio device. The audio device includes: a main speaker unit, a secondary speaker unit, and a processor. The processor is configured to execute the steps of the audio output method as described above.

It should be noted that the processor may specifically be a microcontroller, an FPGA, or various embedded computing units, etc. This embodiment does not impose specific limitations.

Furthermore, as shown in FIG. 7, the audio device may include a processing apparatus 1001 (e.g., a central processing unit, a graphics processing unit, etc.), which may perform various appropriate actions and processes according to a program stored in a read-only memory (ROM) 1002 or a program loaded from a storage apparatus 1003 into a random access memory (RAM) 1004. In the RAM 1004, various programs and data required for the operation of the audio device are also stored. The processing apparatus 1001, the ROM 1002, and the RAM 1004 are connected to each other via a bus 1005. An input/output (I/O) interface 1006 is also connected to the bus. Typically, the following systems may be connected to the I/O interface 1006: an input apparatus 1007 including, for example, a touch screen, a touchpad, a keyboard, a mouse, an image sensor, a microphone, an accelerometer, a gyroscope, etc.; an output apparatus 1008 including, for example, a liquid crystal display (LCD), a speaker, a vibrator, etc.; a storage apparatus 1003 including, for example, a magnetic tape, a hard disk, etc.; and a communication apparatus 1009. The communication apparatus 1009 may allow the audio device to communicate wirelessly or via wire with other devices to exchange data. Although the figure shows an audio device with various systems, it should be understood that it is not required to implement or possess all the shown systems. More or fewer systems may alternatively be implemented or possessed.

In particular, according to the embodiments disclosed in the present application, the processes described above with reference to the flowcharts may be implemented as computer software programs. For example, the embodiments disclosed in the present application include a computer program product, which includes a computer program carried on a computer-readable medium, and the computer program contains program code for executing the method shown in the flowchart. In such embodiments, the computer program may be downloaded and installed from a network via the communication apparatus, or installed from the storage apparatus 1003, or installed from the ROM 1002. When the computer program is executed by the processing apparatus 1001, the above functions defined in the methods of the embodiments disclosed in the present application are executed.

The audio device provided by the embodiments of the present application adopts the audio output method in the above embodiments, which can solve the technical problem of how to improve the privacy of open-ear headphones when using them. Compared with the prior art, the beneficial effects of the audio device provided by the present application are the same as the beneficial effects of the audio output method provided in the above embodiments, and other technical features in the audio device are the same as the features disclosed in the method of the previous embodiment, which will not be repeated here.

It should be understood that the various parts disclosed in the present application may be implemented in hardware, software, firmware, or a combination thereof. In the description of the above embodiments, specific features, structures, materials, or characteristics may be combined in any one or more embodiments or examples in a suitable manner.

The above descriptions are only specific implementations of the present application, but the protection scope of the present application is not limited thereto. Any person skilled in the art can easily think of changes or substitutions within the technical scope disclosed in the present application, which should be covered within the protection scope of the present application. Therefore, the protection scope of the present application should be subject to the protection scope of the claims.

Furthermore, to achieve the above purpose, an embodiment of the present application further provides a readable storage medium having computer-readable program instructions (i.e., a computer program) stored thereon. The computer-readable program instructions are configured to execute the audio output method in the above embodiments. The computer-readable storage medium provided by the embodiments of the present application may be, for example, a USB flash drive, but is not limited to an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In this embodiment, the computer-readable storage medium may be any tangible medium containing or storing a program, which can be used by or in conjunction with an instruction execution system, apparatus, or device. The program code contained on the computer-readable storage medium may be transmitted using any appropriate medium, including but not limited to: wires, optical cables, RF (Radio Frequency), etc., or any suitable combination of the above.

The above computer-readable storage medium may be included in the audio device; or it may exist separately without being assembled into the audio device.

The above computer-readable storage medium carries one or more programs. When the one or more programs are executed by the audio device, the audio device is caused to: obtain an original signal to be output, obtain a target signal based on the original signal; output the original signal through a main speaker unit, and output the target signal through a secondary speaker unit; wherein, if the secondary speaker unit is forward-connected, within a preset frequency range, the original signal and the target signal have opposite phases and identical signal amplitudes; if the secondary speaker unit is reverse-connected, within the preset frequency range, the original signal and the target signal have identical phases and identical signal amplitudes.

Computer program code for carrying out operations of the present application may be written in one or more programming languages or a combination thereof, including object-oriented programming languages such as Java, Smalltalk, C++, and conventional procedural programming languages such as the “C” language or similar programming languages. The program code may execute entirely on the user's computer, partly on the user's computer, as a stand-alone software package, partly on the user's computer and partly on a remote computer, or entirely on the remote computer or server. In the case of a remote computer, the remote computer may be connected to the user's computer through any kind of network, including a local area network (LAN) or a wide area network (WAN), or may be connected to an external computer (e.g., through the Internet using an Internet Service Provider).

The flowcharts and block diagrams in the accompanying drawings illustrate the architecture, functionality, and operation of possible implementations of systems, methods, and computer program products according to various embodiments of the present application. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules involved in the embodiments of the present application may be implemented in software or hardware. The name of a module does not, in some cases, constitute a limitation on the unit itself.

The readable storage medium provided by the present application is a computer-readable storage medium. The computer-readable storage medium stores computer-readable program instructions (i.e., a computer program) for executing the above audio output method, which can solve the technical problem of how to improve the privacy of open-ear headphones when using them. Compared with the prior art, the beneficial effects of the computer-readable storage medium provided by the present application are the same as the beneficial effects of the audio output method provided in the above embodiments, which will not be repeated here.

Furthermore, an embodiment of the present application further proposes a computer program product, including an audio output program. When the audio output program is executed by a processor, the steps of the audio output method as described above are implemented. The specific implementation of the computer program product of the present application is basically the same as each embodiment of the above audio output method, which will not be repeated here.

It should be noted that, in this document, the terms “comprise”, “include”, or any other variant thereof are intended to cover a non-exclusive inclusion, such that a process, method, article, or system that includes a series of elements includes not only those elements but also other elements not expressly listed, or elements inherent to such process, method, article, or system. In the absence of further restrictions, an element defined by the phrase “comprising a . . . ” does not exclude the presence of additional identical elements in the process, method, article, or system that includes the element.

The sequence numbers of the above embodiments of the present application are merely for description and do not represent the (superiority or inferiority) of the embodiments. Through the description of the above implementation modes, those skilled in the art can clearly understand that the above embodiment methods can be implemented by means of software plus a necessary general hardware platform, and of course, can also be implemented by hardware, but in many cases the former is a better implementation mode. Based on such understanding, the technical solution of the present application, or the part that contributes to the prior art, can be embodied in the form of a software sensor. The computer software sensor is stored in a storage medium (such as ROM/RAM, magnetic disk, optical disk) as described above, and includes several instructions to enable a terminal device (which may be a mobile phone, computer, server, air conditioner, or network device, etc.) to execute the methods described in various embodiments of the present application.

The above are only some embodiments of the present application, and are not intended to limit the scope of the present application. Any equivalent structure or equivalent process transformation made by using the contents of the specification and drawings of the present application, or directly or indirectly applied to other related technical fields, are similarly included in the scope of the present application.

What is claimed is:

1. An audio output method, applied to an audio device, wherein the audio device comprises a main speaker unit and a secondary speaker unit, and the audio output method comprises the following steps:
obtaining an original signal to be output, and obtaining a target signal based on the original signal; and
outputting the original signal through the main speaker unit, and outputting the target signal through the secondary speaker unit,
wherein in response to that the secondary speaker unit is forward-connected, the original signal and the target signal have opposite phases and identical signal amplitudes within a preset frequency range; or
in response to that the secondary speaker unit is reverse-connected, the original signal and the target signal have identical phases and identical signal amplitudes within the preset frequency range.

2. The audio output method according to claim 1, wherein when the secondary speaker unit is reverse-connected, the step of obtaining the target signal based on the original signal comprises:
performing filtering processing on the original signal to obtain a first filtered signal and a second filtered signal, wherein the first filtered signal is a signal whose signal frequency belongs to the preset frequency range, and the second filtered signal is a signal whose signal frequency does not belong to the preset frequency range;
obtaining a first signal based on the first filtered signal, wherein the first signal and the first filtered signal have identical phases and identical signal amplitudes;
obtaining a second signal based on the second filtered signal, wherein the second signal and the second filtered signal have opposite phases; and
combining the first signal and the second signal to obtain the target signal.

3. The audio output method according to claim 2, wherein the audio device further comprises a phase inverter and an equalizer connected in sequence, and the step of obtaining the second signal based on the second filtered signal comprises:
inputting the second filtered signal to the phase inverter to output a phase-inverted signal; and
inputting the phase-inverted signal to the equalizer to output the second signal.

4. The audio output method according to claim 2, wherein the audio device further comprises a low-pass filter, a high-pass filter, and a band-pass filter, a cutoff frequency of the low-pass filter is a lower limit value of the preset frequency range, a cutoff frequency of the high-pass filter is an upper limit value of the preset frequency range, a passband frequency range of the band-pass filter is the preset frequency range, and the step of performing filtering processing on the original signal to obtain the first filtered signal and the second filtered signal comprises:
inputting the original signal to the low-pass filter to output a low-frequency signal;
inputting the original signal to the high-pass filter to output a high-frequency signal;
inputting the original signal to the band-pass filter to output a mid-high frequency signal; and
determining the mid-high frequency signal as the first filtered signal, and determining the low-frequency signal and the high-frequency signal as the second filtered signal.

5. The audio output method according to claim 1, wherein the audio device further comprises a first power amplifier and a second power amplifier, the first power amplifier is connected to the main speaker unit, the second power amplifier is connected to the secondary speaker unit, and before the step of outputting the original signal through the main speaker unit and outputting the target signal through the secondary speaker unit, the method further comprises:
inputting the original signal to the first power amplifier, so as to amplify the original signal through the first power amplifier and drive the original signal to the main speaker unit for output; and
inputting the original signal to the second power amplifier, so as to amplify the target signal through the second power amplifier and drive the target signal to the secondary speaker unit for output.

6. The audio output method according to claim 1, wherein the preset frequency range is a frequency range between a front cavity resonance frequency of the secondary speaker unit and a rear cavity resonance frequency of the secondary speaker unit.

7. The audio output method according to claim 6, wherein the rear cavity resonance frequency of the secondary speaker unit is less than 2 kHz, and the front cavity resonance frequency of the secondary speaker unit is greater than the rear cavity resonance frequency of the secondary speaker unit.

8. An audio device, comprising a main speaker unit, a secondary speaker unit, and a processor, wherein the main speaker unit and the secondary speaker unit are respectively connected to the processor, and the processor is configured to execute the steps of the audio output method according to claim 1.

9. A non-transitory computer-readable storage medium, wherein a computer program is stored on the readable storage medium, and when the computer program is executed by a processor, the steps of the audio output method according to claim 1 are implemented.

10. A computer program product, comprising a computer program, wherein when the computer program is executed by a processor, the steps of the audio output method according to claim 1 are implemented.
